(19) United States
(12) Patent Application Publication
(10) Pub. No.: US 2010/0088587 A1
(43) Pub. Date: Apr. 8, 2010

(54) METHOD AND APPARATUS FOR PROVIDING INTER-VERSION DOCUMENT COMPATIBILITY

(75) Inventors: Wei Ding, Beijing (CN); Zhang Hao, Beijing (CN); Shun Jiang, Beijing (CN); Chun hua Tian, Beijing (CN)

Correspondence Address: IBM CORPORATION, T.J. WATSON RESEARCH CENTER, P.O. BOX 218, YORKTOWN HEIGHTS, NY, 10598, US

(73) Assignee: INTERNATIONAL BUSINESS MACHINES CORPORATION, Armonk, NY (US)

(21) Appl. No.: 12/567,053

(22) Filed: Sep. 25, 2009

(30) Foreign Application Priority Data
Sep. 26, 2008 (CN) 200810166375.X

(51) Int. Cl. G06F 17/00

(52) U.S. Cl. 715/229; 715/234

(57) ABSTRACT

A method and an apparatus for providing inter-version document compatibility. The apparatus includes: a conversion stack which includes differentiation models between data models of different versions of an application; and a conversion module for converting between documents of different versions of the application by using the conversion stack, so as to provide compatibility between the documents of different versions of the application.

### CROSS REFERENCE TO RELATED APPLICATION

This application claims priority under 35 U.S.C. 119 from Chinese Patent Application 200810166375.X, filed Sep. 26, 2008, the entire contents of which are incorporated herein by reference.

### BACKGROUND OF THE INVENTION

1. Field of the Invention

The present invention relates to the field of data processing, and in particular, to a method and apparatus for providing inter-version document compatibility.

2. Description of Related Art

Most computer programs are modified by designers again and again to add new functions and to correct bugs, thus forming a plurality of release versions of the computer programs. Each release version is usually given a particular number as the version number or release number.

“Backward compatibility” means that a newer release version of a computer program can read a document generated by an earlier release version of the computer program. For example, Visio 2007 of Microsoft can be used to open a document created by Visio 2003. “Forward compatibility” means that an earlier release version of a computer program can read a document generated by a newer release version of the computer program. For example, Visio 2003 of Microsoft can be used to open a document created by Visio 2007.

Backward compatibility and forward compatibility are key considerations when designers design computer programs. Especially, backward compatibility has been a basic requirement for modern computer programs. However, making a computer program to include the function of backward compatibility or forward compatibility has brought great extra complexity to program development.

In a collaborating work environment, for example, within an enterprise, it is very difficult to update all desktop applications in a timely manner, and hence different versions of an application may exist at the same time. Different versions of an application usually correspond to different versions of a data model, which makes people who use the different versions of the application hard to cooperate with each other.

For example, FIG. 1 illustrates an exemplary scenario, in which a user who uses a version 2.0 application has a document which needs to be modified by a user who uses a version 1.0 application. Since it is often the case that a lower version program is unable to read a document produced by a higher version program, a conventional method is to develop a converter program to perform model conversion between versions.

However, such a conventional method has several defects. For example, in common situations, a program has many versions. Thus, it is necessary to develop many converters and thereby great efforts are needed. It is difficult to test the converters. When the converters convert between documents of different versions, it is easy to lose information. Because the converters are usually standalone applications, they need to be maintained and distributed separately. This causes large amounts of work for both administrators and users of the applications.

### SUMMARY OF THE INVENTION

In one aspect of the present invention, a method performed in a data processing machine provides inter-version document compatibility, by performing the steps of: providing a conversion stack which includes differentiation models between data models of different versions of an application; and converting between documents of different versions of the application by using the conversion stack to provide compatibility between the documents of the different versions of the application.

In another aspect of the present invention, computer readable instructions are tangibly embodied in a computer readable medium. When the computer executes the instructions, it is caused to perform the above process steps.

In still another aspect of the present invention, an apparatus provides inter-version document compatibility. The apparatus includes: a conversion stack which includes differentiation models between data models of different versions of an application; and a conversion module configured for converting between documents of different versions of the application by using the conversion stack, so as to provide compatibility between the documents of the different versions of the application.

An advantage of the present invention is that it is not necessary to develop a special converter for document conversion between each pair of versions. A general conversion module, a merging module, and a verification module are sufficient so that time and effort required for providing forward/backward compatibility for program designers and developers are reduced. In addition, in embodiments of the present invention, loss of information at the time of document conversion is avoided by providing the merging module. Accordingly, the present invention provides a more convenient and low-cost solution for providing inter-version document compatibility.

### BRIEF DESCRIPTION OF THE DRAWINGS

The present invention and its preferred modes, objects, features and advantages will be better understood by referring to the detailed description of the exemplary embodiments when read in conjunction with the attached drawings, in which:

FIG. 1 schematically illustrates a scenario where users using different versions of an application need to cooperate with each other for modification of a document;

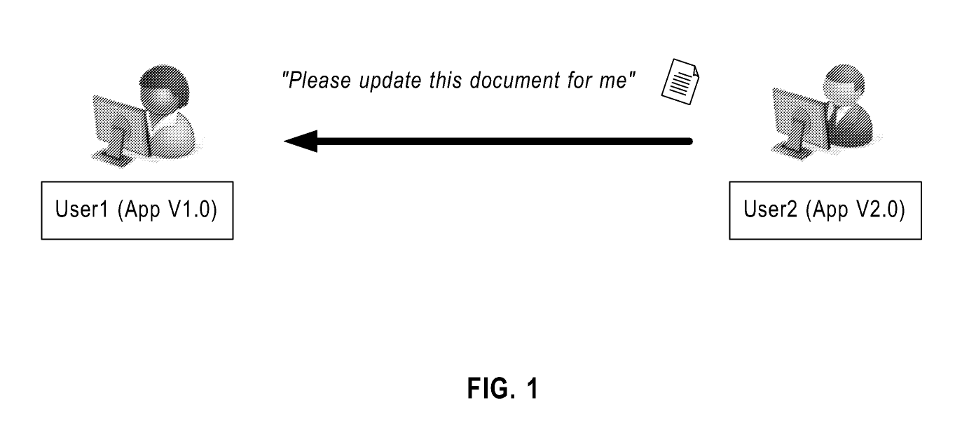

FIG. 2 shows an apparatus for providing inter-inversion document compatibility according to an embodiment of the present invention;

FIG. 3 shows an example of data models of different versions of an exemplary application;

FIG. 4 schematically shows an exemplary editor application editing a document in a user interface and an object graph of the document in a memory;

FIG. 5 shows an exemplary data model instance represented in XML format;

FIG. 6 shows an exemplary operation process that an apparatus according to an embodiment of the present invention provides inter-version document compatibility, wherein the apparatus is in the application of each version;

FIG. 7 shows an exemplary operation process that an apparatus according to another embodiment of the present invention provides inter-version document compatibility, wherein the apparatus is at a network server and is for providing inter-version conversion of documents as a network server;

FIG. 8 illustrates a method for providing inter-version document compatibility according to an embodiment of the present invention;

FIG. 9 shows the sub-steps included in the step of conversion between documents of different versions of an application by using a conversion stack according to an embodiment of the present invention; and

FIG. 10 shows the sub-steps included in the step of conversion between documents of different versions of an application by using a conversion stack according to another embodiment of the present invention.

### DETAILED DESCRIPTION OF PREFERRED EMBODIMENTS

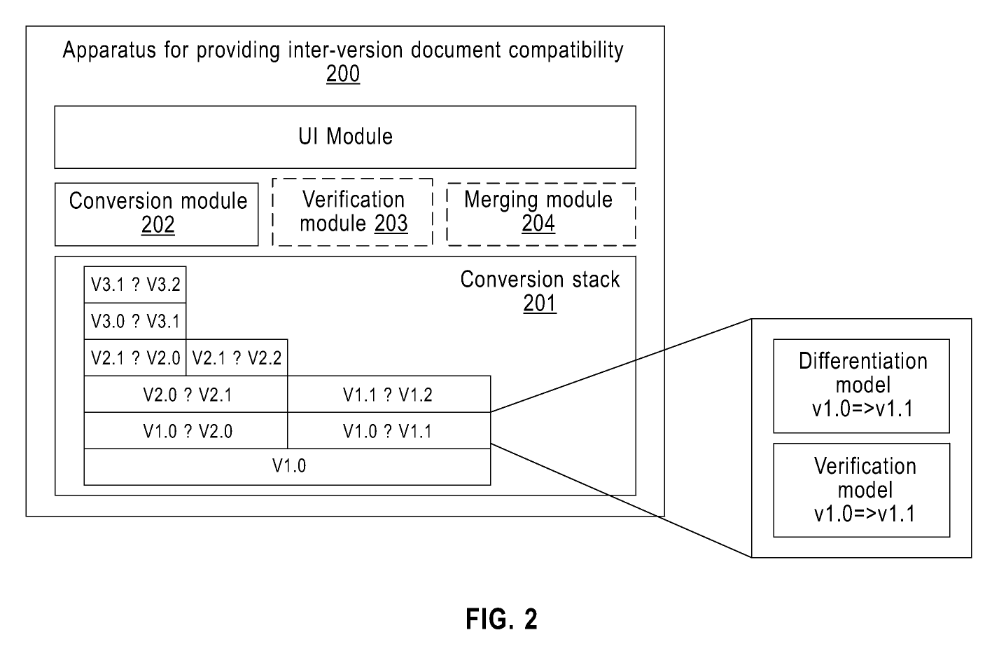

FIG. 2 shows an apparatus for providing inter-version document compatibility according to an embodiment of the present invention. The apparatus 200 includes: a conversion stack 201 which includes differentiation models between different versions of the data model of an application; and a conversion module 202 for converting between documents of different versions of the application by using the conversion stack 201, so as to provide compatibility between documents of different versions of the application.

According to an embodiment of the present invention, the differentiation models between data models of different versions of an application are differentiation models between the data models of adjacent versions of the application. By including only the differentiation models between the data model of adjacent versions, in stead of differentiation models between the data models of any two versions, especially when the application has many versions, the number of the differentiation models that must be maintained is reduced significantly; and the conversion stack 202 can still realize conversion between documents of any two versions by performing one or more conversions using one or more differentiation models between the data models of the two versions. The adjacent versions usually means consecutive versions in the evolution process of an application, that is, if one version is developed based on another version, the version and the other version are adjacent versions.

For example, the conversion stack 201 shown in FIG. 2 includes differentiation models between the adjacent versions 1.0 and 1.1, 1.1 and 1.2, 1.0 and 2.0, 2.0 and 2.1, 2.1 and 2.2, 2.1 and 3.0, 3.0 and 3.1, 3.1 and 3.2. The conversion stack 201 shown in FIG. 2 reflects a relatively complex version evolution process which includes branches, wherein versions 1.0, 1.0, 1.2 are one version evolution branch, versions 1.0, 2.0, 2.1 and 2.2 are another version evolution branch, and versions 1.0, 2.0, 2.1, 3.0, 3.1, 3.2 are still another version evolution branch. Of course, the conversion stack shown in FIG. 2 is only exemplary, rather than limitation to the conversion stack of the present invention.

For example, the conversion stack 201 may include differentiation models between adjacent versions in a relatively simple version evolution process (for example, a linear evolution process without branches). In addition, in some other embodiments of the present invention, the conversion stack 201 may include the differentiation models between any two versions in a plurality of versions. In still some other embodiments of the present invention, the conversion stack 201 may include differentiation models between some selected versions in a plurality of versions.

The conversion stack 201 further includes optional verification models which include rules for verifying whether a document conform to constraints of data models, and the apparatus 200 further includes an optional verification module 203 for verify a converted document according to a verification model, so as to enable the converted document to conform to the constraints of the data model of the version as the target of the conversion. The rules can be specified by a user according to a data model and stored in a verification model.

For example, the data model of version 2 requires that a teacher teaches at most 50 students, while the data model of version 3 eliminates the constraint. As such, when converted from version 3 to version 2, the document obtained may not meet the constraint of the data model of version 2. Therefore, a verification model corresponding to version 2 may include the rule requiring that a teacher teaches at most 50 students, and the verification module 203 may check the document converted from version 3 to version 2 according to this rule in the verification model, and inform the user to process when it detects that the document does not conform to the rule.

The apparatus 200 is in an application of each version, and the conversion stack 201 may include differentiation models between data models of this version and lower versions. For example, if the version of the application is V2.1, then the conversion stack 201 in the application may include differentiation models between data models of the versions prior to version V2.1 (for example, between data models of the adjacent versions); if the version of the application is V3.2, then the conversion stack 201 in the application may include differentiation models between data models of the versions prior to version V3.2 (for example, between data models of the adjacent versions), and so on.

According to another embodiment of the present invention, the apparatus 200 is at a network server, and provides document inter-version conversion as a networked service. Thus, the conversion stack 201 is at the network server and includes differentiation models between data models of versions (for example, the adjacent versions) prior to a specific version (for example, the currently latest version) of the application.

In addition, the apparatus 200 may further include an optional user interface (UI) module through which the user can manipulate and control the document conversion process. For example, the UI module may provide a dialog box allowing the user to select a target version of document conversion, and provide another dialog box allowing the user to select the storage location of the data generated during the conversion process, such as documents of intermediate versions.

The apparatus 200 further includes the following optional modules which are not shown: a model extractor for acquiring data models of different versions of an application; a model comparator for generating differentiation models between the data models of different versions of the application according to the data models of different versions of the application, and for storing the differentiation models into the conversion stack 201.

A data model of an application is also referred to as a meta-model or schema of the application and it defines the various data object classes, the attributes and the relationships between them operated by the application, and a document generated by the application is an instance of the data model of the application.

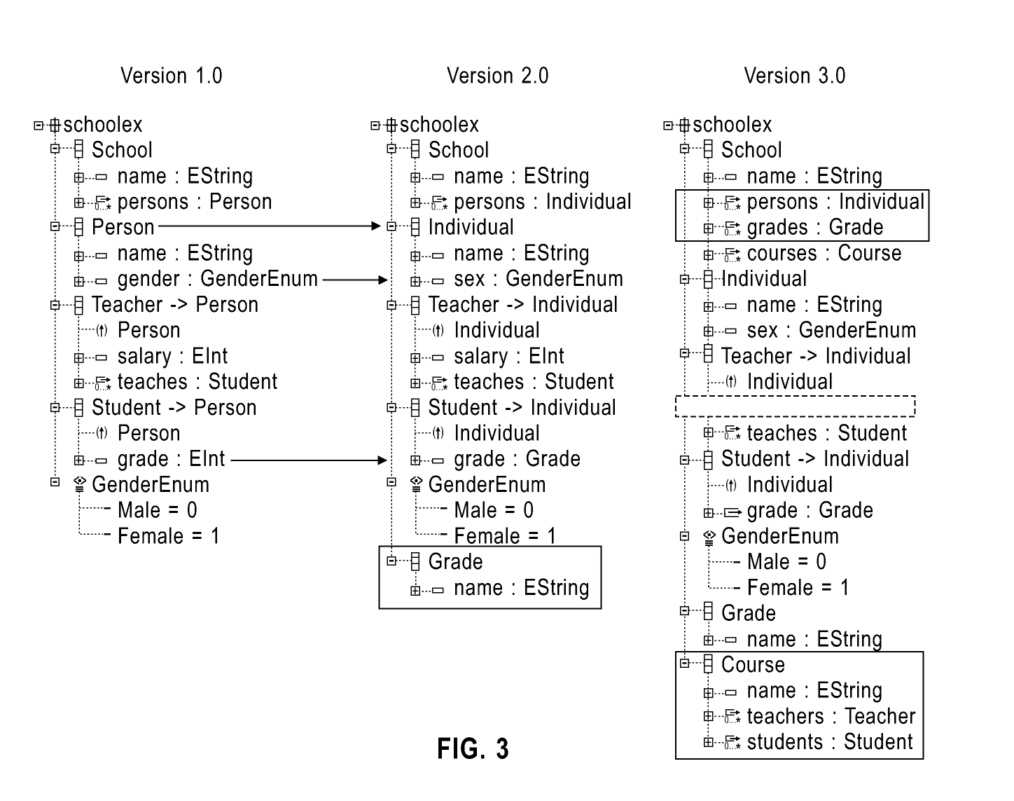

FIG. 3 shows an example of data models of different versions of an application. As shown, by comparing the data model of version 2.0 with the data model of version 1.0, it can be seen that the class Person is renamed as Individual, the attribute gender is renamed as sex, and the type of the attribute grade, EInt, is changed into Grade, additionally a new class, Grade, is added. By comparing the data model of version 3.0 with the data model of version 2.0, it can be seen that the attributes of the class School, grades and courses, are added, and their types are designated as classes Grade and Course, respectively, and the attribute salary of the class School is deleted; in addition, a new class, Course, is added.

During operation, the application can create a document according to its data model, that is, forming an instance of the data model in the memory, namely, an object graph conforming to the data model; and store the document on a disk, that is, serializing the object graph in the memory to a disk file; or load the document from the disk, that is, read the contents of the disk file into the memory and parse the document contents according to the data model, so as to form an object graph conforming to the data model in the memory and display the object graph in an user interface (UI).

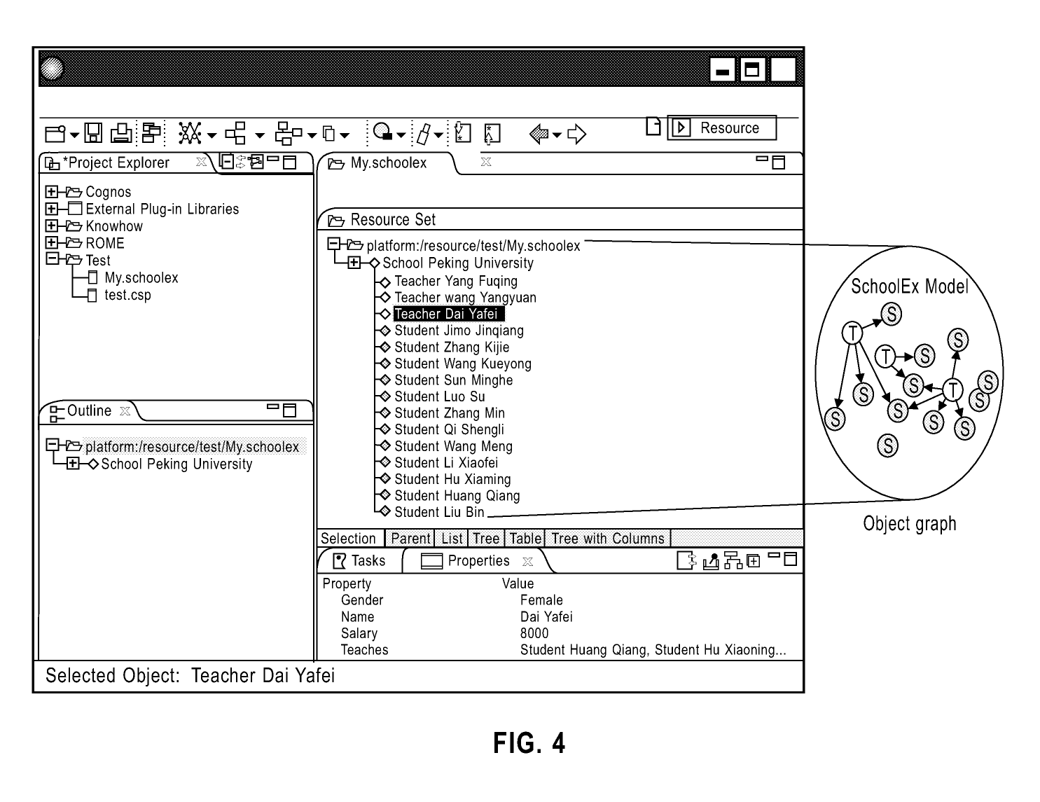

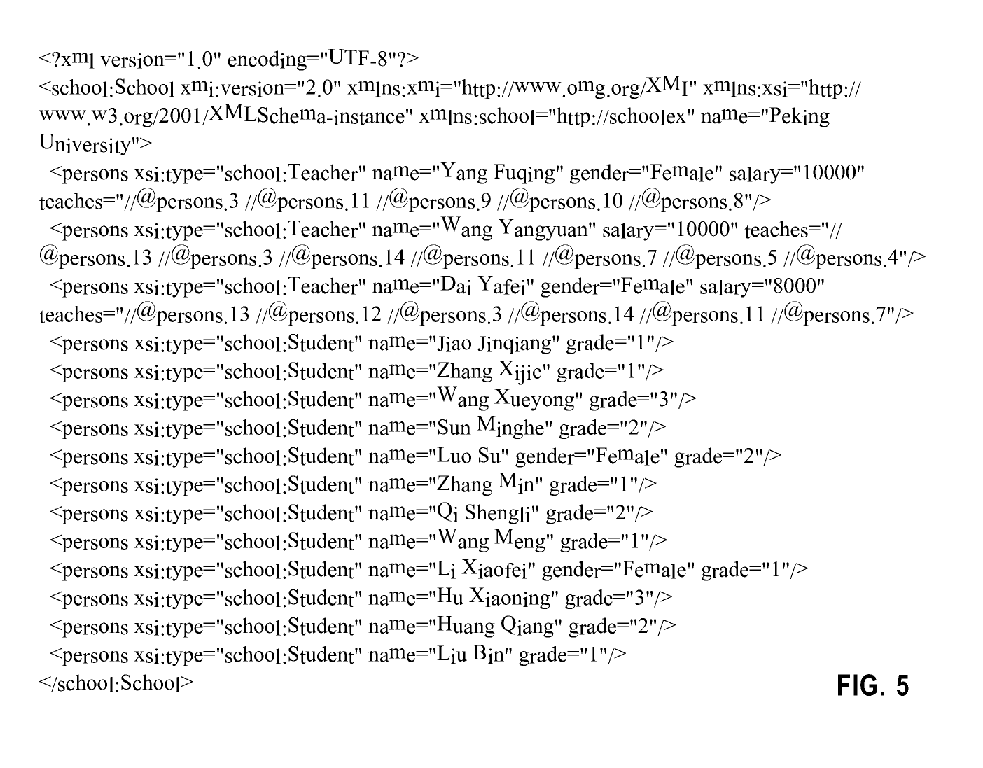

In order for the application to open, read and parse the document contents correctly, the data model used by the application when parsing the document contents must be consistent with the data model used when the document is generated and stored; otherwise, the document cannot be opened, read or parsed, thus arising a compatibility problem. FIG. 4 schematically shows an exemplary editor application editing a document in a user interface and an object graph of the document in the memory. FIG. 5 shows an exemplary data model instance represented in XML format.

The data model of an application is usually described using a formal model description language, e.g., UML, XSD, Ecore, etc. The model extractor may use any one of a plurality of methods known in the art to acquire data models of different versions of an application. For example, a reverse engineering technique can be used to automatically extract the data model of an application from the source code of the application or, for those applications which were developed based on existing data models, the data models of the applications can also be acquired directly.

The model comparator can use a model comparison technique known in the art to compare the data models of different versions, and automatically generate a differentiation model representing the differences between the data models of different versions. For example, an existing model weaving tool, e.g., AMW, can be used to generate the differentiation model. Additionally or alternatively, the user can manually modify or create a differentiation model.

For example, modern model comparison techniques generally use a “minimum edit-distance” hypothesis to find the differences between two models; especially when the number of different elements is very small as compared with the number of total elements, these techniques work well. However, there exist a few cases where the results generated by such a method of automatically finding differences do not reflect the truth. When an attribute “label” in an old data model is deleted, and a new attribute “weight” is created in a new data model, according to the principle of minimum edit-distance, the differentiation model will view “weight” as a substitution for “label”, which is not correct. Therefore, the model comparator may allow the user to modify or edit an automatically generated differentiation model.

For example, with respect to a data model described using UML, the model comparator may acquire the information of adding, deleting or modifying various UML elements, such as, Class, Attribute, Aggregation, Composition, and Generalization between data models of different versions, and record the information in a differentiation model. For example, for the exemplary data models of version 1.0 and version 2.0 shown in FIG. 3, a differentiation model including the following information may be generated: 1) the class “Person” was renamed as “Individual”; 2) the attribute “gender” of the class “Person” was renamed as “sex”; 3) a class “Grade” with an attribute “name” was added; 4) the type of the attribute “grade”, “EInt”, was modified as “Grade”.

The differentiation model may use any known data structure in the art. As long as the differentiation model includes the differences between document data models of different versions so that it can be used for inter-version document conversion, it is feasible. According to an embodiment of the present invention, the conversion stack is any data structure which includes differentiation models between adjacent versions and verification models for verifying the validity of documents.

The conversion module 202 for performing conversion between documents of different versions of an application by using the conversion stack 201 is further configured for performing the following operations: obtaining a document of a higher version; successively converting the document of the higher version into zero, one or more documents of intermediate versions and a document of a lower version by using one or more differentiation models between data models between the higher version and the lower version in the conversion stack 201, and storing the document of the higher version, and the zero, one or more documents of the intermediate versions between the higher version and the lower version or relevant information therein (for example, information lost when the document of one version is converted into the document of another version); sending the document of the low version to the application of the lower version, so as to perform required modifications to the document of the lower version by using the application of the lower version; receiving the modified document of the lower version from the application of the lower version; successively converting the modified document of the lower version into zero, one or more modified documents of intermediate versions and a modified document of the higher version by using the one or more differentiation models between the data models between the higher version and the lower version in the conversion stack 201, and by merging with the stored zero, one or more documents of the intermediary versions between the higher version and the lower version and the document of the higher version or the relevant information therein by a merging module 204; wherein the apparatus 200 further optionally includes a merging module 204 for merging zero, one or more incomplete documents of intermediate versions and an incomplete document of the higher version, which are successively converted from the lower version of documents, with the zero, one or more stored documents of the intermediate versions between the higher version and the lower version and the stored document of the higher version or the related information therein, so as to generate the zero, one or more modified documents of the intermediate versions and the modified document of the higher version.

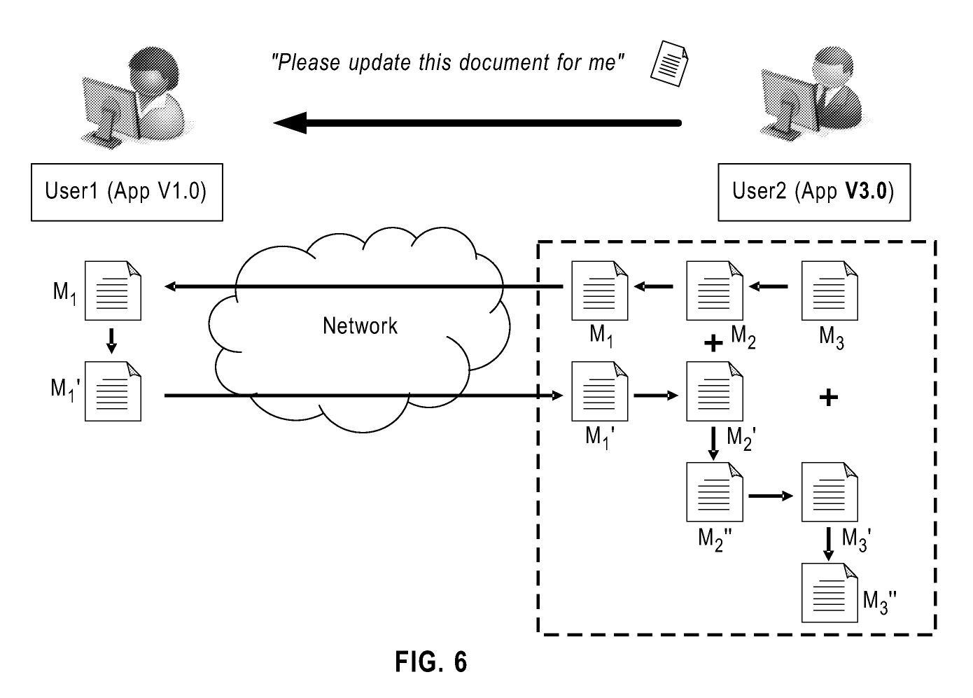

FIG. 6 shows an exemplary operation process by which the apparatus 200 provides inter-version document compatibility, wherein, the apparatus 200 is in applications of each version. As shown, an application of version 3.0 generates or obtains in other manners a document M₃ of version 3.0. The conversion module 202 in the apparatus 200 of the present invention automatically converts the document M₃ of version 3.0 into a document M₂ of version 2.0 by using a differentiation model between the data model of version 2.0 and the data model of version 3.0 (supposing version 3.0 and version 2.0 are adjacent versions) in the conversion stack 201.

Optionally, the optional verification module 203 in apparatus 200 of the present invention can verify the converted document M₂ so as to make the document M₂ conform to the constraints in the data model of version 2.0. Since the data model of version 2.0 may lack some data elements as compared with the data model of version 3.0, thus when the document M₃ of version 3.0 is converted into the document M₂ of version 2.0, some data elements in the document M₃ of version 3.0 may be lost.

Therefore, the verification module 203 or the merging module 204 or any other module in the apparatus 200 of the present invention may store the document of version 3.0 or the relevant information therein (for example, the information lost when it is converted into the document of version 2.0) for a later merging operation, so as to restore the lost data elements.

Next, the conversion module 202 converts the document M₂ of version 2.0 into a document M₁ of version 1.0 (supposing version 2.0 and version 1.0 are adjacent versions) by using the differentiation model between the data model of version 1.0 and the data model of version 2.0.

Also optionally, the optional verification module 203 in the apparatus 200 of the present invention may verify the converted document M₁ so as to make it conform to the constraints in the data model of version 1.0; the verification module 203 or the merging module 204 may store the document M₂ of version 2.0 or the relevant information therein (for example, the information lost when it is converted into the document of version 1.0) for a later merging operation.

Then, the conversion module 202 or any other module in the apparatus 200 of the present invention sends the document M₁ of version 1.0 to an application of version 1.0 through a network, to allow the user who use the application of version 1.0 to modify the document M₁, so as to generate a modified document M₁′ of version 1.0, and send back the document M₁′ to the application of version 3.0 through the network.

Next, the conversion module 202 automatically converts the modified document M₁′ of version 1.0 into a document M₂′ of version 2.0 by using the differentiation model between the data model of version 1.0 and the data model of version 2.0 in the conversion stack 201.

Also optionally, the optional verification module 203 in the apparatus 200 of the present invention can verify the automatically converted document M₂′ to make it conform to the constraints in the data model of version 2.0. The merging module 204 merges the stored document M₂ of version 2.0 or the relevant information therein with the document M₂′ of version 2.0, which was converted or further modified and verified, to obtain a modified complete document M₂″ of version 2.0.

Then the conversion module 202 converts the modified complete document of version 2.0 into a document M₃′ of version 3.0 by using the differentiation model between the data model of version 2.0 and the data model of version 3.0 in the conversion stack 201.

Also optionally, the optional verification module 203 in the apparatus 200 of the present invention can verify the automatically converted document M₃′ to make it conform to the constraints in the data model of version 3.0. And the merging module 204 can merge the stored document M₃ of version 3.0 or the relevant information therein with the converted or further modified or verified document M₃′ of version 3.0 to obtain a modified complete document M₃″ of version 3.0, and provide the document M₃″ to the user as a final document. In this way, the entire operation process of the apparatus 200 providing inter-version document compatibility of the present invention is accomplished.

Of course, although the above example shows a scenario where one application version 2.0 exists between two application versions 3.0 and 1.0 which are used by two users respectively, the apparatus 200 of the present invention is applicable to situations where there exist any more or zero intermediate versions between the two application versions used by two users respectively.

The conversion module 202 can use any model conversion method known in the art, for example, QVT, ATL, VIATRA, GReAT, Tefkat, Kermeta, MT, SiTra, etc., to convert a document conforming to the data model of one version into a document conforming to the data model of another version according to corresponding inter-version differentiation models.

As for class elements in data models, if a differentiation model indicates a class element is added in a new data model as compared with an old data model, since the old document does not have the class element, the class element will not be taken into consideration when the old document is converted into a new document; if the differentiation model indicates that a class element has been deleted from the new data model as compared with the old data model, then when the old document is converted into the new document, the data segments of which the type is the deleted class in the old document need to be deleted; if the differentiation model indicates that the name of a class element in the new data model change as compared with the name of the class element in the old data model, then when the old document is converted into the new document, the class name of the old document needs to be replaced by the corresponding new class name.

As for attribute elements in the data models, if the differentiation model indicates that an attributes element is added in the new data model as compared with the old data model, since the attribute element does not exist in the old document, the attribute element needs not to be considered when the old document is converted into the new document; if the differentiation model indicates that an attribute element has been deleted from the new data model as compared with the old data model, when the old document is converted into the new document, the data segments of which the type is the attribute deleted in the old document need to be deleted; if the differentiation model indicates that the name of an attribute element in the new data model changes with respect to the name of an attribute element in the old data model, then when the old document is converted into the new document, the attribute name in the old document needs to be replaced with the corresponding new attribute name.

As for the addition, deletion or modification of other elements included in the data model, e.g., the aggregation, composition, generalization, etc. of UML, similar processing is performed.

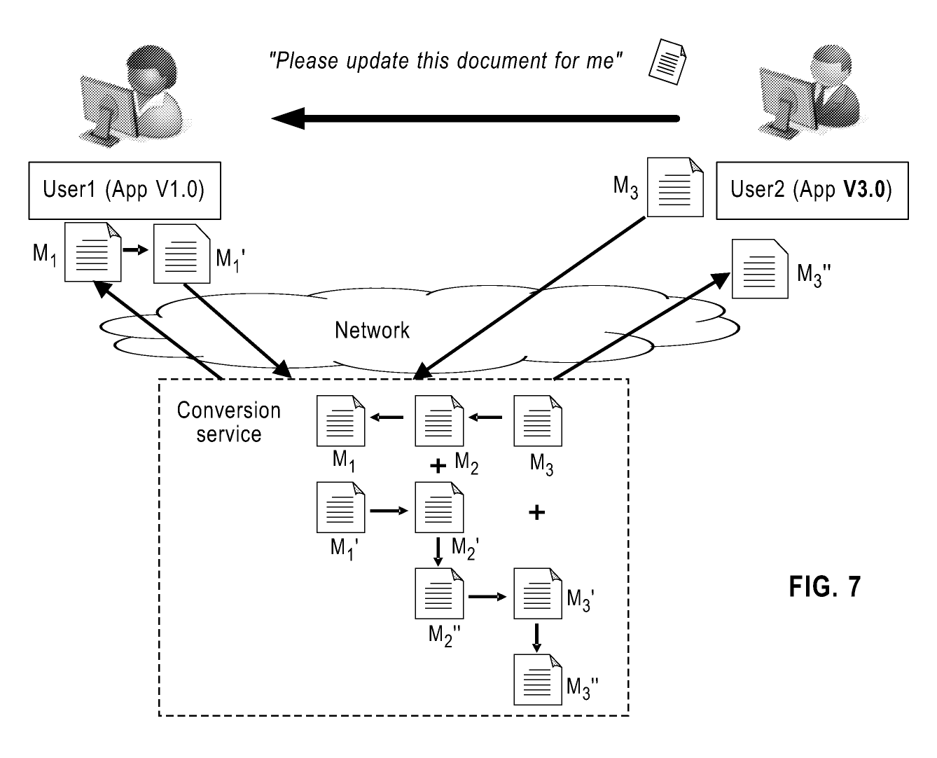

FIG. 7 shows an exemplary operation process that the apparatus 200 according to another embodiment of the present invention provides inter-version document compatibility, wherein the apparatus 200 is at a network server and provides inter-version conversion of documents as a networked service. The operation process includes the following steps.

In step 1 a user, User 2, sends a document M₃ of version 3.0 to a model transformation service (MTS for short) provided by the apparatus 200 of the present invention, and informs the MTS of the application version 1.0 of another user, User 1.

In step 2, the MTS automatically generates an ID of the document based on the account of User 2, the document title and the time.

In step 3, the MTS automatically converts the document M₃ into a document M₁ conforming to the application version 1.0 of the User 1 (possibly through conversion to one or more intermediate versions, as well as merging and verification operations), and sends a link to the converted document M₃ to User 2 as a feedback, and the link includes the ID of the document.

In step 4, User 2 sends the link including the document ID to User 1 through a network.

In step 5, User 1 uses the link to download the converted document M₁ from the MTS, and modifies the document M₁ to obtain a document M₁′.

In step 6, User 1 uploads the modified document M₁′ and the document ID to the MTS.

In step 7, the MTS automatically converts the document M₁′ into a modified document M₃′ of version 3.0 (possibly through conversion to one or more intermediate versions, and merging and verification operations), and provides another link to the document M₃′ to User1.

In step 8, User 1 notifies the link to User2 via the network.

In step 9, User 2 downloads the modified document M₃′ using the link.

In accordance with another embodiment of the present invention, the conversion module 202 for converting documents of different versions of the application by using the conversion stack 201 is further configured for: receiving a document of a lower version from an application of the lower version; successively converting the document of the lower version into zero, one or more documents of intermediate versions between a higher version and the lower version and a document of the higher version by using one or more differentiation models between data models between the higher version and the lower version in the conversion stack 201, and storing the document of the lower version, and the zero, one or more documents of intermediate versions between the higher version and the lower version or the relevant information therein; providing the document of the higher version to an application of the higher version, so as to perform required modifications to the document of the higher version by the application of the higher version; successively converting the modified document of the higher version into zero, one or more modified documents of intermediate versions, and a modified documents of the lower version, by using the one or more differentiation models between the data models between the higher version and the lower version in the conversion stack 201 and by merging successively with the zero, one or more stored documents of intermediate versions between the higher version and the lower version and the document of the lower version or the relevant information therein through the merging model 204; and sending the modified document of the lower version to the application of the lower version; wherein the apparatus 200 further includes the merging module 204 for: successively merging zero, one or more incomplete documents of intermediate versions and an incomplete document of the lower version successively converted from the modified document of the higher version with the zero, one or more stored documents of intermediate versions between the higher version and the lower version and the document of the lower version or the relevant information therein, to generate the zero, one or more modified documents of intermediate versions, and the modified document of the lower version.

Thus, in an application scenario of this embodiment, different from the application scenario of the embodiment shown in FIG. 6 where the converting processing is performed on a document of a higher version in an application of higher version, and then the converted document is sent to an application of a lower version so as to be modified and returned by the application of lower version, and is converted again in the application of the higher version to generate a modified document of the higher version, it is that an application of the lower version sends a document of the lower version to an application of higher version and is converted by the application of the higher version, and after being modified by the application of the higher version, is converted again to generate a modified document of the lower version, and sent to the application of the lower version.

Although, in the exemplary scenario shown in FIG. 6, the user using the application of a higher version converts a document of the higher version into a document of a lower version by the apparatus 200 of the present invention and sends it to the user using the application of the lower version for modification, and then receives a modified document of the lower version from the application of the lower version, and converts the modified document of the lower version into a modified document of the higher version, the apparatus 200 according to an embodiment of the present invention is also suitable for another scenario, wherein a user using an application of a lower version sends a document of the lower version to a user using an application of a higher version, and the user using the application of the higher version modifies the document of the lower version after converting it into a document of the higher version by the apparatus 200 of the present invention, and converts the modified document of the higher version into a modified document of the lower version and sends it to the user using the application the lower version of.

Similarly, although in the exemplary scenario show in FIG. 7, the user using the application of a higher version sends a document of the higher version to the apparatus 200 of the present invention at the network server, and the apparatus 200 of the present invention converts it into a document of a lower version and provides it to the user using the application of a lower version for modification, who then sends the modified document of the lower version to the apparatus 200 of the present invention, and the apparatus 200 of the present invention converts it into a modified document of the higher version and sends the modified document of the higher version to the user using the higher version, the apparatus 200 according to the present invention is also suitable for another scenario, wherein a user using the application of a lower version sends a document of the lower version to the apparatus 200 of the present invention at a network server, and the apparatus 200 of the present invention converts it into a document of a higher version, and sends it to a user using the application of a higher version, who then sends a modified document of the higher version to the apparatus 200 of the present invention, and the apparatus 200 of the present invention converts it into a modified document of the lower version and sends the modified document of the lower version to the user using the lower version.

According to another embodiment of the present invention, the conversion module 202 for converting between documents of different versions of an application by using a conversion stack 201 is further configured for: obtaining a document of a first version; successively converting the document of the first version into zero, one or more documents of intermediate versions between the first version and the second version and a document of the second version by using one or more differentiation models between data models between the first version and the second version in the conversion stack; and providing the document of the second version.

Providing the document of the second version may include, for example, sending the document through a network or providing it in other manners to a user who uses the application of the second version, so that the user can check or modify it, or directly displaying the document on a user interface of the application of the second version, and the like.

The above describes the apparatus 200 for providing inter-version document compatibility according to an embodiment of the present invention. It should be pointed out that the above description is only exemplary, rather than limiting to the scope of the present invention. Compared with what is described, the apparatus 200 of the present invention can have more, fewer or different modules and the connection and containment relationships between the modules can be different. Part of or all the functions of each of the above modules can also be accomplished by other existing or new modules.

For example, according to some embodiments of the present invention, the apparatus 200 may exclude one or more of the above optional modules; the apparatus 200 can further include a receiving module specialized for sending and receiving documents, and so on. All these variations are within the spirit and scope of the present invention.

The method for providing inter-version document compatibility can be executed according to an embodiment of the present invention by the apparatus 200 for providing inter-version document compatibility according to an embodiment of the present invention or any other device. For brevity, part of the details repetitive with the above description is omitted in the following description. Therefore, a more detailed understanding of the method of the present invention can be obtained by referring to the above description.

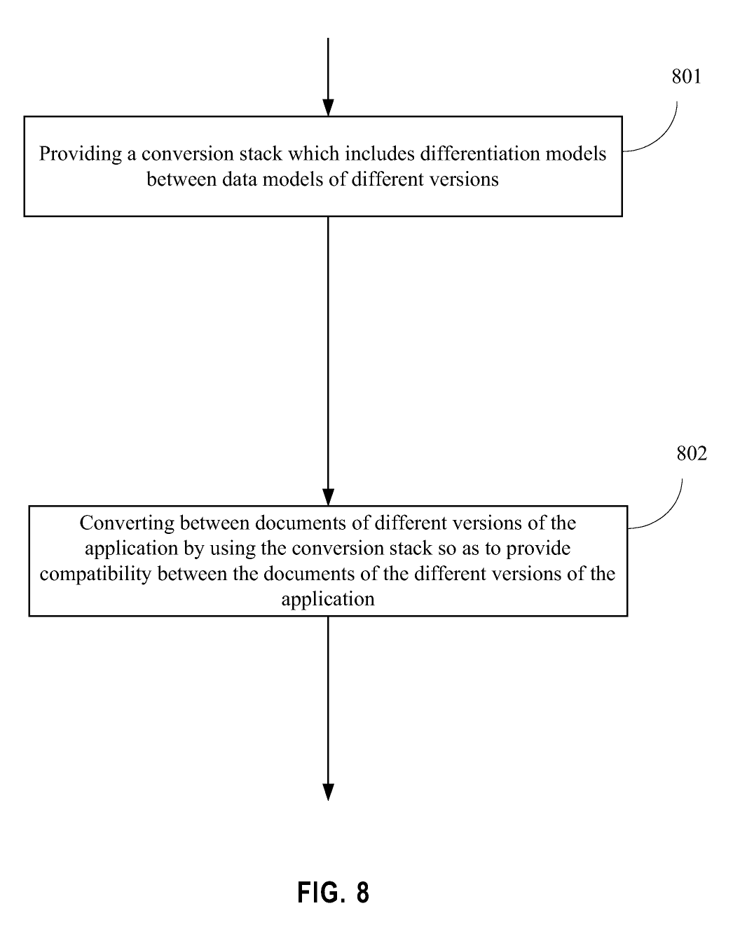

FIG. 8 shows a method for providing inter-version document compatibility according to an embodiment of the present invention. As shown in the figure, the method includes following steps.

In step 801, a conversion stack is provided, and the conversion stack includes differential models between data models of different versions of an application.

In step 802, the conversion stack is used to convert between documents of different versions of the application, so as to provide compatibility between documents of different versions of the application.

According to an embodiment of the present invention, the differentiation models between data models of the different versions of the application are differentiation models between the data models of adjacent versions of the application.

According to an embodiment of the present invention, the conversion stack is in the application of each version, and includes differentiation models between the data models of the version and lower versions, and the conversion is performed in the application of the version.

According to an embodiment of the present invention, the conversion stack is at a network server, and the conversion is executed as a networked service at the network server.

According to an embodiment of the present invention, the step 801 for providing the conversion stack includes the following sub-steps: obtaining data models of different versions of the application; and generating differentiation models between the data models of different versions of the application according to the data models of different versions of the application, and storing the differentiation models to the conversion stack.

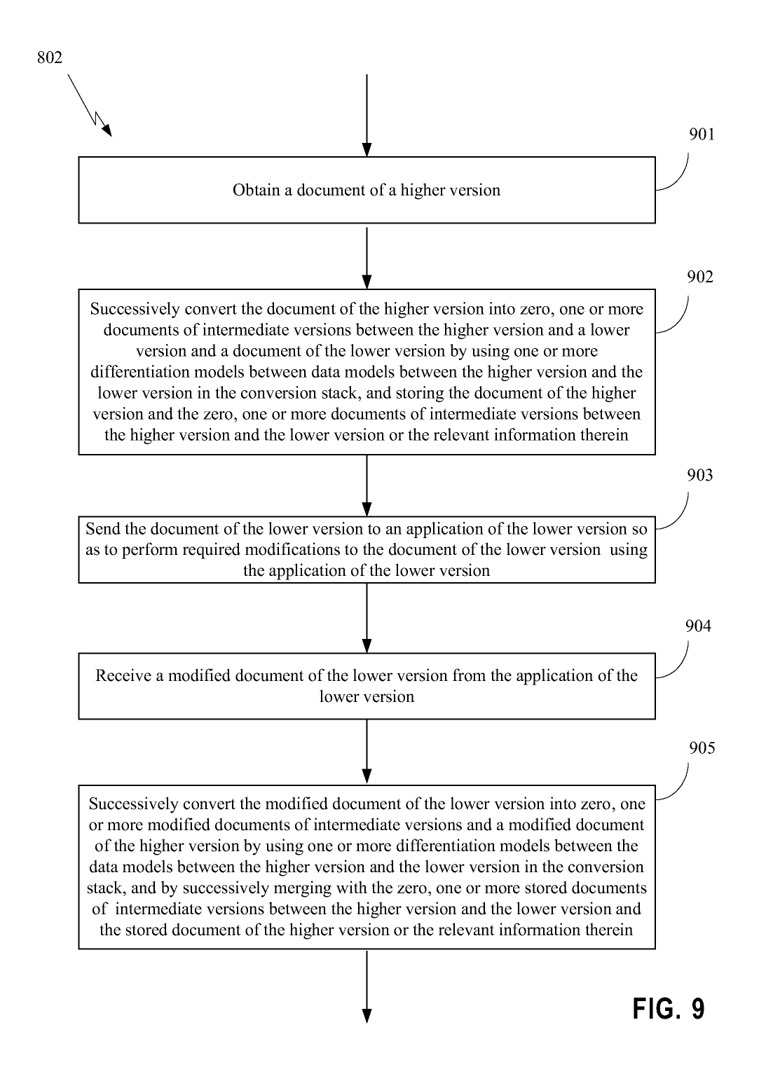

Now referring to FIG. 9, it shows the sub-steps included in the step 802 for converting between documents of different versions of an application by using the conversion stack according to an embodiment of the present invention.

As shown, a document of a higher version is obtained in step 901.

In step 902, the document of the higher version is successively converted into zero, one or more documents of intermediate versions between the higher version and the lower version and the document of the lower version by using one or more differentiation models between data models between the higher version and the lower version in the conversion stack, and the document of the higher version and the zero, one or more documents of intermediate versions between the higher version and the lower version or the relevant information therein are stored.

In step 903, the document of the lower version is sent to the application of the lower version, so as to require modifications to the document of the lower version may be performed by using the lower version of the application.

In step 904, a modified document of the lower version is received from the application of the lower version.

In step 905, the modified document of the lower version is converted into zero, one or more modified documents of intermediate versions and a modified document of the higher version by using the one or more differentiation models between the data models between the higher version and the lower version in the conversion stack and by successively merging with the zero, one or more stored documents of intermediate versions between the higher version and the lower version and the stored document of the higher version or the relevant information therein.

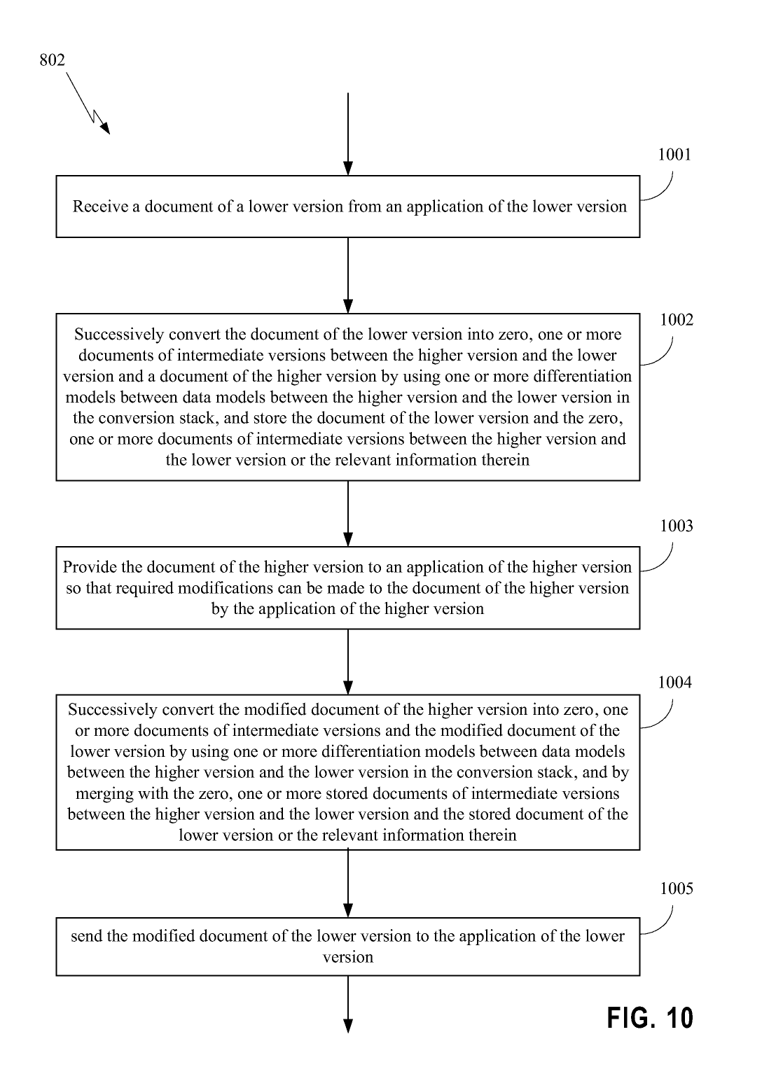

Now referring to FIG. 10, it shows the sub-steps included in the step 802 for converting between documents of different versions of an application by using the conversion stack according to another embodiment of the present invention.

As shown, in step 1001, a document of a lower version from the application of the lower version is received.

In step 1002, the document of the lower version is successively converted into zero, one or more documents of intermediate versions between the higher version and the lower version and a document of the higher version by using one or more differentiation models between data models between the higher version and the lower version in the conversion stack, and the document of the lower version and the zero, one or more documents of the intermediate versions between the higher version and the lower version or the relevant information therein are stored.

In step 1003, the document of the higher version is provided to the application of the higher version so that required modifications can be made to the document of the higher version by the application of the higher version.

In step 1004, the modified document of the higher version is successively converted into zero, one or more documents of the intermediate versions and a modified document of the lower version by using one or more differentiation models between data models between the higher version and the lower version in the conversion stack, and by merging successively with the zero, one or more stored documents of the intermediate versions between the higher version and the lower version and the stored document of the lower version or the relevant information therein.

In step 1005, the modified document of the lower version is sent to the application of the lower version.

According to still another embodiment of the present invention, the step 802 for converting different versions of documents of the application by the conversion stack includes the following sub-steps: first, obtaining a document of a first version; second, successively converting the document of the first version into zero, one or more documents of intermediate versions between the first version and the second version and a document of the second version by using one or more differentiation models between data models between the first version and the second version in the conversion stack; finally, providing the document of the second version.

According to an embodiment of the present invention, the conversion further includes verifying a converted document according to the data model of the version as the conversion target, so as to make the converted document conform to the data model.

The above described a method for providing inter-version document compatibility according to an embodiment of the present invention. It should be pointed out that, the above description is only exemplarily, rather than limitation to the present invention. Compared with that is described, the method can have more, fewer or different steps, and the orders between the steps can be different or they can be executed in parallel. For example, in some embodiments of the present invention, the method may exclude one or more of the above optional steps.

The present invention can be realized by hardware, software, or a combination thereof. The present invention can be implemented in a single computer system in a centralized manner, or in a distributed manner in which different components are distributed in several inter-connected computer systems. Any computer system or other devices suitable for executing the method described herein are all suitable. A typical combination of hardware and software can be a general-purpose computer system with a computer program, which when being loaded and executed, controls the computer system to execute the method of the present invention and constitutes the apparatus of the present invention.

The present invention can also be embodied in a computer program product, which includes all the features that enable to realize the methods described herein, and when being loaded into a computer system, can execute the method.

Although the present invention has been illustrated and described with reference to preferred embodiments, those skilled in the art will appreciate that various changes in form and details can be made thereto without departing from the spirit and scope of the present invention.

What is claimed is:

1. A method performed in a data processing machine for providing inter-version document compatibility, comprising the steps of:
providing a conversion stack which includes differentiation models between data models of different versions of an application; and
converting a document of one version of an application to a document of another version by using the conversion stack to provide compatibility between the documents of the different versions of the application.

2. The method of claim 1, wherein the differentiation models between data models of different versions of the application are differentiation models between data models of adjacent versions of the application.

3. The method of claim 1, wherein the converting step further comprises:
obtaining a document of a first version;
successively converting the document of the first version into at least one document of an intermediate version between the first version and a second version and a document of the second version by using one or more differentiation models between data models between the first version and the second version in the conversion stack; and
providing the document of the second version.

4. The method according to claim 1, wherein the converting step further comprises:
obtaining a document of a higher version;
successively converting the document of the higher version into documents of intermediate versions between the higher version and a lower version and a document of the lower version by using at least one differentiation model between data models between the higher version and the lower version in the conversion stack, and storing the document of the higher version and the documents of intermediate versions between the higher version and the lower version or the relevant information therein;
sending the document of the lower version to an application of the lower version so that required modifications to the document of the lower version may be performed by the application of the lower version;
receiving a modified document of the lower version from the application of the lower version; and
successively converting the modified document of the lower version into modified documents of intermediate versions and a modified document of the higher version by using at least one differentiation model between data models between the higher version and the lower version in the conversion stack, and by successively merging with the stored documents of intermediate versions between the higher version and the lower version and the stored document of the higher version or the relevant information therein.

5. The method of claim 1, wherein the converting step comprises:
receiving a document of a lower version from an application of the lower version;
successively converting the document of the lower version into documents of intermediate versions between a higher version and the lower version and a document of the higher version by using at least one differentiation models between data models between the higher version and the lower version in the conversion stack, and storing the document of the lower version and the documents of intermediate versions between the higher version and the lower version or the relevant information therein;
providing the document of the higher version to an application of the higher version, so that required modifications to the document of the higher version is performed by the application of the higher version;
successively converting the modified document of the higher version into modified documents of intermediate versions and a modified document of the lower version by using one or more differentiation models between data models between the higher version and the lower version in the conversion stack, and by successively merging with the stored documents of intermediate versions between the higher version and the lower version and the document of the lower version or the relevant information therein; and
sending the modified document of the lower version to the application of the lower version.

6. The method of claim 1, wherein the conversion stack further comprises;
a verification model which contains rules for verifying whether a document conforms to a data model, and the conversion further comprises verifying a converted document according to the verifying module, so as to make the converted document conform to the data model of the version as the conversion target.

7. The method of claim 1, wherein the conversion stack is in an application of each version and includes differentiation models between data models of the version and lower versions, and the conversion is executed in the application of the version.

8. The method of claim 1, wherein the conversion stack is in a network server and the conversion is executed as a networked service in the network server.

9. The method of claim 1, wherein providing the conversion stack further comprises:
obtaining the data models of different versions of the application; and
generating the differentiation models between data models of different versions of the application according to the data models of the different versions of the application, and storing the differentiation models into the conversion stack.

10. An apparatus for providing inter-version document compatibility, comprising:
a conversion stack which includes differentiation models between data models of different versions of an application; and
a conversion module configured for converting between documents of different versions of the application by using the conversion stack, so as to provide compatibility between the documents of the different versions of the application.

11. The apparatus of claim 10, wherein differentiation modes between data models of different versions of the application are differentiation models between data models of adjacent versions of the application.

12. The apparatus of claim 10, wherein the conversion module is further configured for:
obtaining a document of a first version;
successively converting the document of the first version into documents of intermediate versions between the first version and a second version and a document of the second version by using one or more differentiation models between data models between the first version and the second version in the conversion stack; and
providing the document of the second version.

13. The apparatus according to claim 10, wherein the conversion module is further configured for:
obtaining a document of a higher version;
successively converting the document of the higher version into documents of intermediate versions between the higher version and a lower version and a document of the lower version by using one or more differentiation models between data models between the higher version and the lower version in the conversion stack, and storing the document of the higher version and the documents of intermediate versions between the higher version and the lower version or the relevant information therein;
sending the document of the lower version to an application of the lower version so that required modifications to the document of the lower version may be performed by the application of the lower version;
receiving a modified document of the lower version from the application of the lower version; and
successively converting the modified document of the lower version into modified documents of intermediate versions and a modified document of the higher version by using at least one differentiation model between data models between the higher version and the lower version in the conversion stack, and by successively merging with the at least one stored document of intermediate versions between the higher version and the lower version and the stored document of the higher version or the relevant information therein through a merging module.

14. The apparatus of claim 13, further comprising:
a merging module configured for successively merging at least one incomplete document of intermediate versions and an incomplete document of the higher version successively converted from the modified document of the lower version with the at least one stored document of intermediate versions between the higher version and the lower version and the stored document of the higher version or the relevant information therein, to generate the at least one modified document of intermediate versions, and the modified document of the higher version.

15. The apparatus of claim 10, wherein the conversion module is further configured for:
receiving a document of a lower version from an application of the lower version;
successively converting the document of the lower version into documents of intermediate versions between a higher version and the lower version and a document of the higher version by using at least one differentiation model between data models between the higher version and the lower version in the conversion stack, and storing the document of the lower version, and the documents of intermediate versions between the higher version or the lower version or the relevant information therein;
providing the document of the higher version to an application of the higher version, so that required modifications to the document of the higher version is performed by the application of the higher version;
successively converting the modified document of the higher version into at least one modified documents of intermediate versions and a modified document of the lower version by using at least one differentiation model between data models between the higher version and the lower version in the conversion stack, and by successively merging with stored documents of intermediate versions between the higher version and the lower version and the document of the lower version or the relevant information therein through a merging module; and
sending the modified document of the lower version to the application of the lower version.

16. The apparatus of claim 15, further comprising:
a merging module configured for successively merging incomplete documents of intermediate versions and an incomplete document of the lower version successively converted from the modified document of the higher version with the stored documents of intermediate versions between the higher version and the lower version and the stored document of the lower version or the relevant information therein, so as to generate the modified documents of intermediate versions and the modified document of the lower version.

17. The apparatus of claim 10, wherein;
the conversion stack further includes a verification model which contains rules for verifying whether a document conform to a data model; and
the apparatus further comprises a verification module configured for verifying a converted document according to the verification model so as to make the converted document conform to the data model of the versions as the conversion target.

18. The apparatus of claim 10, further comprising:
a model extractor for obtaining the data models of different versions of an application; and
a model comparator for generating differentiation models between data models of different versions of the application according to the data models of different versions of the application, and storing the differentiation models in the conversion stack.

19. A computer readable article of manufacture tangibly embodying computer readable instructions which, when executed by the computer, cause the computer to carry out the steps of:
providing a conversion stack which includes differentiation models between data models of different versions of an application; and
converting between documents of different versions of the application by using the conversion stack to provide compatibility between the documents of the different versions of the application.
